(19) United States
(12) Patent Application Publication
(10) Pub. No.: US 2023/0168034 A1
(43) Pub. Date: Jun. 1, 2023

(54) VACUUM FREEZE-DRYING METHOD, INJECTION NOZZLE FOR A VACUUM FREEZE-DRYING APPARATUS, AND VACUUM FREEZE-DRYING APPARATUS

(71) Applicant: ULVAC, INC., Chigasaki-shi, Kanagawa (JP)

(72) Inventors: Sora UEMATSU, Chigasaki-shi, Kanagawa (JP); Hiromu MATSUBAYASHI, Chigasaki-shi, Kanagawa (JP); Tsutomu NISHIHASHI, Chigasaki-shi, Kanagawa (JP); Masaki ITOU, Chigasaki-shi, Kanagawa (JP); Tsuyoshi YOSHIMOTO, Chigasaki-shi, Kanagawa (JP); Susumu ARAI, Chigasaki-shi, Kanagawa (JP); Nobuhiro MOTEGI, Chigasaki-shi, Kanagawa (JP)

(21) Appl. No.: 17/996,985

(22) PCT Filed: Apr. 30, 2021
(86) PCT No.: PCT/JP2021/017138

§ 371 Date: Oct. 24, 2022

(30) Foreign Application Priority Data
Aug. 7, 2020 (JP) 2020-134678
Oct. 5, 2020 (JP) 2020-168279

(51) Int. Cl. F26B 5/06

(52) U.S. Cl. CPC F26B 5/065; A23L 3/44

(57) ABSTRACT

[Object] To freeze droplets of a raw material liquid in a shorter drop distance while maintaining a cooling velocity, which is a super high speed, without deteriorating a solute or dispersoid.

[Solving Means] A vacuum freeze-drying method according to an embodiment of the present invention is a vacuum freeze-drying method that includes steps of injecting a raw material liquid from an injection nozzle inside a vacuum chamber, generating frozen particles by self-freezing of the raw material liquid, and drying the generated frozen particles to thereby produce a dry powder, including: injecting the raw material liquid from the injection nozzle in a state in which the vacuum chamber is maintained at water vapor partial pressure corresponding to a self-freezing temperature of the raw material liquid, such that an injection initial velocity of the raw material liquid from the injection nozzle is 6 m/s or more and 33 m/s or less; and adjusting, when the maximum diameter of the generated frozen particle exceeds a predetermined value or droplets of the raw material liquid are unfrozen, an injection flow rate of the raw material liquid from the injection nozzle or properties of the injection nozzle such that frozen particles having a maximum diameter equal to or smaller than the predetermined value are generated.

### TECHNICAL FIELD

The present invention relates to a vacuum freeze-drying method that injects a liquid such as a liquid medicine into a vacuum through an upper portion of a vacuum chamber, generates frozen particles by self-freezing, and then dries the frozen particles to thereby produce powder, to an injection nozzle for a vacuum freeze-drying apparatus, and to a vacuum freeze-drying apparatus.

### BACKGROUND ART

In recent years, as to a vacuum freeze-drying apparatus, a vacuum freeze-drying method and a vacuum freeze-drying apparatus that directly inject a liquid into a vacuum from an injection nozzle, generate frozen particles by self-freezing using evaporation of moisture, and then dry the frozen particles to thereby produce a powder have been proposed (e.g., see Patent Literature 1, 2). In this vacuum freeze-drying method, minute droplets are formed and evaporated in a vacuum where the moisture pressure is lower, and therefore it is characterized in that freezing can be performed at a super high speed of 1 second or less due to its latent heat and also the ice crystals are minute.

Such a vacuum freeze-drying technology can directly obtain a freeze-dried powder from a liquid, and therefore it can produce various types of powders. For example, this freeze-drying technology can prevent deterioration of food products, concentration of pharmaceuticals, and the like due to moisture and obtain a high-quality dry matter. Moreover, since drying is performed by subliming ice, the sublimation amount also increases due to an increase in temperature. Therefore, the process of depositing a frozen powder on a metal tray inside a vacuum chamber and heating the metal tray to increase the temperature of the frozen powder and dry the frozen powder is conventionally performed in order to reduce the drying time.

However, in such a conventional technology, in a case where an injection initial velocity of a raw material liquid into a vacuum chamber is higher, in a case where a solvent the freezing point of which significantly drops is used as the raw material liquid, and also in a case where vacuum evacuation in a freezing tank is insufficient, a freezing tank longer (larger in height) is required for freezing droplets of the solvent, with the result that the apparatus increases in size, which has been a problem.

For example, Patent Literature 1 has described mass production process and apparatus that form, sublime, and dry minute frozen powder particles of a liquid medicine or the like in a vacuum. However, there is a possibility that the apparatus may increase in size depending on a condition of each step, the apparatus itself may increase in costs, and the production efficiency may lower in terms of the costs and time because the costs and time for cleaning and maintaining the apparatus increase.

Moreover, Patent Literature 2 relating to the vacuum freeze-drying method and the vacuum freeze-drying apparatus has described some liquid medicine injection conditions but has not described injection conditions and moisture pressure conditions for reducing the apparatus size, and therefore it has not disclosed an effective means.

### CITATION LIST

### Patent Literature

Patent Literature 1: Japanese Patent Application Laid-open No. 2004-232883
Patent Literature 2: Japanese Patent Application Laid-open No. 2006-90671

### DISCLOSURE OF INVENTION

### Technical Problem

As described above, Patent Literature 1 and Patent Literature 2 have not described a cooling velocity necessary for preventing deterioration of the raw material liquid at the time of freezing and injection conditions of the raw material liquid for realizing it. Thus, Patent Literature 1 and Patent Literature 2 had not disclosed an effective means that can contribute to size reduction of the apparatus.

In view of the above-mentioned circumstances, it is an object of the present invention to provide a vacuum freeze-drying method, an injection nozzle for a vacuum freeze-drying apparatus, and a vacuum freeze-drying apparatus, by which droplets of a raw material liquid can be frozen in a shorter travel distance while maintaining a cooling velocity, which is a super high speed, without deteriorating a solute or dispersoid.

### Solution to Problem

A vacuum freeze-drying method according to an embodiment of the present invention is a vacuum freeze-drying method that includes steps of injecting a raw material liquid from an injection nozzle inside a vacuum chamber, generating frozen particles by self-freezing of the raw material liquid, and drying the generated frozen particles to thereby produce a dry powder, including:

injecting the raw material liquid from the injection nozzle in a state in which the vacuum chamber is maintained at water vapor partial pressure corresponding to a self-freezing temperature of the raw material liquid, such that an injection initial velocity of the raw material liquid from the injection nozzle is 6 m/s or more and 33 m/s or less; and adjusting, under a condition where a cooling velocity from 20° C. to −25° C. in a case where the injection initial velocity is 13 m/s is 5900° C./s or more, an injection flow rate of the raw material liquid from the injection nozzle or properties of the injection nozzle such that frozen particles having a maximum diameter of 200 μm or less are generated.

It is thus possible to generate frozen particles having a maximum diameter of 200 μm or less that does not deteriorate a solute or dispersoid and to produce frozen particles of the raw material liquid in a shorter travel distance (1 m or less). Therefore, the vacuum freeze-drying apparatus can be reduced in size.

An injection nozzle for a vacuum freeze-drying apparatus according to an embodiment of the present invention is an injection nozzle that is an injection nozzle for a vacuum freeze-drying apparatus that injects a raw material liquid at an injection initial velocity of 6 m/s or more and 33 m/s or less inside a vacuum chamber and generates frozen particles by self-freezing of the raw material liquid, including:

an inflow surface that defines an inflow port for the raw material liquid;

an injection surface that defines an injection port for the raw material liquid; and

a hole inner surface that defines an injection hole for causing the inflow port and the injection port to communicate with each other, in which

at least one of the inflow surface or the injection surface is a target surface, and

a region in which a contact angle decreases in a direction of facing the hole inner surface from the target surface is provided in a surface constituted by the target surface and the hole inner surface.

With the configuration, a liquid positioned at a boundary between the surface in which the contact angle is larger and the surface in which the contact angle is smaller produces driving force for flowing from the surface in which the contact angle is larger to the surface in which the contact angle is smaller. With the nozzle for vacuum spray-freezing, such driving force based on the contact angle difference is produced in the direction of facing the hole inner surface from the target surface. As a result, in a case where the target surface is the injection surface, the raw material liquid produces driving force to return the raw material liquid in a direction of facing the hole inner surface from the injection surface. Accordingly, scattering of the raw material liquid around the injection port is suppressed. In a case where the target surface is the inflow surface, the raw material liquid produces driving force to force the raw material liquid to flow in a direction of facing the hole inner surface from the inflow surface. Accordingly, the raw material liquid is forced to flow into the injection hole without stagnation at the start of injection of the raw material liquid or the end of injection of the raw material liquid. That is, a smooth flow of the raw material liquid is realized. Therefore, the raw material liquid can be injected at a desired injection initial velocity, and it is thus possible to generate frozen particles having a maximum diameter of 200 μm or less that does not deteriorate a solute or dispersoid and to realize a compact vacuum freeze-drying apparatus capable of producing frozen particles of a raw material liquid in a shorter travel distance (1 m or less).

### Advantageous Effects of Invention

In accordance with the present invention, it is possible to freeze droplets of a raw material liquid in a shorter drop distance while maintaining a cooling velocity, which is a super high speed, without deteriorating a solute or dispersoid.

### BRIEF DESCRIPTION OF DRAWINGS

FIG. 1 A schematic configuration diagram showing an entire vacuum freeze-drying apparatus according to an embodiment of the present invention.

FIG. 2 A graph showing a relationship between a water, ice temperature and a saturation water vapor pressure.

FIG. 3 A graph calculating a relationship between a drop distance with respect to a droplet diameter and a droplet temperature in a case where the water vapor partial pressure in the freezing chamber is maintained at 50 Pa and droplets of pure water are formed at an initial velocity of 13 m/s from the injection nozzle.

FIG. 4 A graph calculating a relationship between a droplet drop time and the droplet temperature under the same condition.

FIG. 5 A graph showing a relationship between a hole diameter of the injection nozzle and a mean droplet diameter.

FIG. 6 A graph showing plus or minus twice the mean droplet diameter and the standard deviation of droplets formed when injecting pure water at various injection flow rates from the injection nozzle having a hole diameter of 100 as an error bar.

FIG. 7 A graph showing a relationship between an injection pressure of a raw material liquid in the injection nozzle and an injection initial velocity.

FIG. 8 A schematic cross-sectional view showing a configuration example of the injection nozzle.

FIG. 9 A cross-sectional view showing an example of a cross-sectional structure of an injection nozzle for a vacuum freeze-drying apparatus according to another embodiment of the present invention.

FIG. 10 A cross-sectional view showing another example of the cross-sectional structure of the injection nozzle.

FIG. 11 A cross-sectional view showing another example of the cross-sectional structure of the injection nozzle.

FIG. 12 A cross-sectional view showing another example of the cross-sectional structure of the injection nozzle.

### MODE(S) FOR CARRYING OUT THE INVENTION

Hereinafter, embodiments of the present invention will be described with reference to the drawings.

### First Embodiment

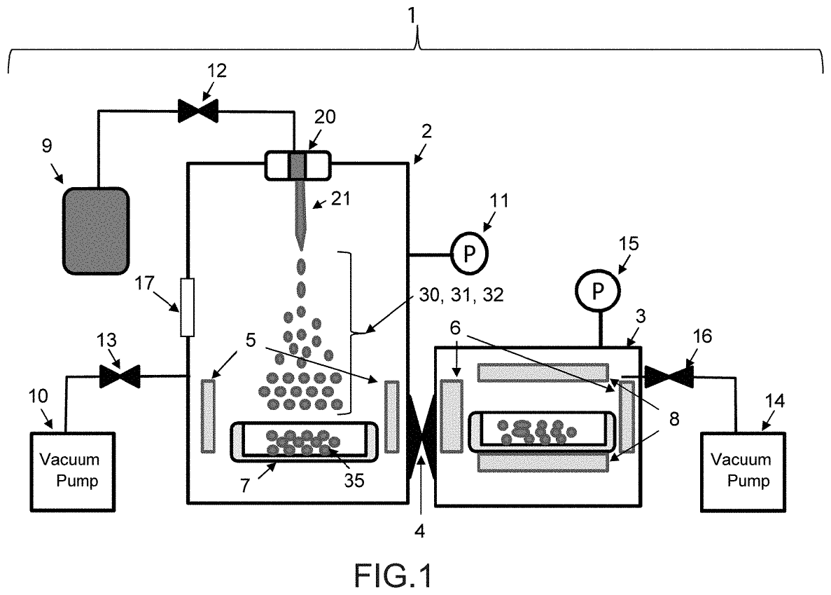

FIG. 1 is a schematic configuration diagram showing an entire vacuum freeze-drying apparatus 1 according to an embodiment of the present invention. First of all, an overall configuration of the vacuum freeze-drying apparatus 1 will be described.

[Overall Configuration of Apparatus]

As shown in FIG. 1, the vacuum freeze-drying apparatus 1 according to this embodiment includes a vacuum chamber including a freezing chamber 2 and a drying chamber 3 connected to the freezing chamber 2 via a gate valve 4.

The freezing chamber 2 is connected to a carrying-in chamber (not shown) and connected to a vacuum evacuation apparatus 10 via an exhaust amount adjustment apparatus 13.

A vacuum evacuation apparatus 14 is connected to the drying chamber 3 via an exhaust amount adjustment apparatus 16, and a vent valve (not shown) for pressure recovery (exposure to the atmosphere) is provided. Moreover, a vacuum gauge 11 and a vacuum gauge 15 are connected to the freezing chamber 2 and the drying chamber 3, respectively, in order to measure internal pressures.

A raw material tank 9 that stores a raw material liquid at a normal temperature is placed outside the freezing chamber 2. An injection nozzle 20 connected to the raw material tank 9 is provided in an upper portion in the freezing chamber 2. Then, the raw material liquid is supplied into the injection nozzle 20 from the raw material tank 9 via a raw material liquid supply amount adjustment apparatus 12, and the raw material liquid is injected into a vacuum atmosphere downward from a lower end portion of the injection nozzle 20, having a liquid column shape.

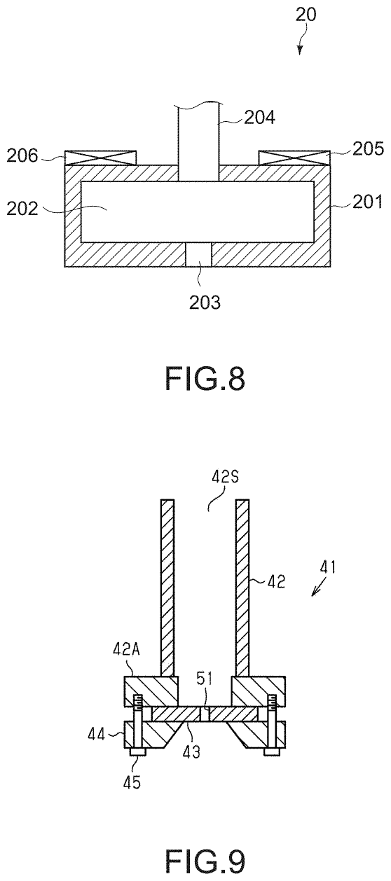

FIG. 8 is a schematic configuration diagram showing a configuration example of the injection nozzle 20. The injection nozzle 20 has a nozzle main body 201. A liquid holding unit 202 formed of a cylindrical space or the like is provided inside the nozzle main body 201. A nozzle hole 203 is formed in a bottom portion of the liquid holding unit 202. A pipe 204 that is in communication with the raw material liquid supply amount adjustment apparatus 12 is connected to an upper portion of the liquid holding unit 202.

A diameter (hereinafter, also referred to as hole diameter) of the nozzle hole 203 can be arbitrarily set in a range of 20 μm or more and 100 μm or less, for example. Moreover, a plurality of nozzle holes having different hole diameters (e.g., a hole having a diameter of 50 μm and a hole having a diameter of 100 μm) may be prepared in advance as the nozzle hole 203, and a mechanism unit capable of selectively switching an arbitrary nozzle hole manually or automatically may be provided.

The nozzle hole 203 may be a circular hole formed with a constant diameter perpendicular to the bottom portion of the liquid holding unit 202 or may be a tapered circular hole that gradually decreases in diameter toward an outflow end of the raw material liquid.

In addition, the injection nozzle 20 may include a vibration element 206 or the like that vibrates a heating element 205 that heats the nozzle main body 201 at a predetermined temperature and the nozzle main body 201 at a predetermined frequency. Accordingly, the surface friction of the nozzle hole 203 with respect to the raw material liquid (kinematic viscosity of the raw material liquid on the nozzle surface) can be adjusted.

It should be noted that in the following description, hole diameter and hole shape of the injection nozzle 20, surface friction and contact angle of the nozzle hole 203, and the like will be also referred to as properties of the injection nozzle 20, collectively. Moreover, the raw material liquid supply amount adjustment apparatus 12 and a mechanism unit or element that adjusts the properties of the injection nozzle 20 are in this embodiment configured as an injection amount adjustment apparatus that adjusts an injection flow rate of the raw material liquid.

It should be noted that assuming that the properties of the injection nozzle 20 are a pipe resistance in supplying the raw material liquid, it is correlated to injection initial velocity and injection pressure of the raw material liquid from the injection nozzle 20, and therefore the raw material liquid supply amount adjustment apparatus 12 is configured to comprehensively control adjustment of these properties. With such a configuration, the raw material liquid supply amount adjustment apparatus 12 is capable of controlling the pipe resistance, and therefore it can be an apparatus that makes the injection initial velocity and injection pressure more stable. An example of the control method for the properties of the injection nozzle 20 can be a configuration capable of automatic control and manual switching for each lot.

The raw material liquid supply amount adjustment apparatus 12 typically includes a flow rate control valve, a liquid delivery pump, and the like. The raw material liquid supply amount adjustment apparatus 12 adjusts the injection flow rate of the raw material liquid injected into the freezing chamber 2 from the injection nozzle 20. In this embodiment, the raw material liquid supply amount adjustment apparatus 12 adjusts the supply amount of the raw material liquid with respect to the injection nozzle 20 or the injection pressure of the raw material liquid from the injection nozzle 20 such that the injection initial velocity of the raw material liquid from the injection nozzle 20 is 6 m/s or more and 33 m/s or less.

It should be noted that a configuration in which the raw material tank 9 and the raw material liquid supply amount adjustment apparatus 12 are integrated may be employed. An example can be a syringe pump.

As shown in FIG. 1, a tray 7 that holds the generated frozen particles 35 of the raw material liquid is arranged below the injection nozzle 20 inside the freezing chamber 2. In this embodiment, a distance to the tray 7 from the injection nozzle 20 is installed within 1 m. That is, the vacuum freeze-drying apparatus 1 is configured to be capable of generating the frozen particles 35 of the raw material liquid at a height position equal to or higher than 1 m from the injection nozzle 20.

A cold trap 5 connected to a freezer (not shown) is provided in vicinity of the tray 7. When the frozen particles decrease in size, a rate of the frozen particles that are collected into the tray lowers the flow of the water vapor through the cold trap, and therefore it is favorably that the cold trap 5 is installed near the tray.

The tray 7 is configured to be conveyed into the drying chamber 3 from the freezing chamber 2 through a conveying mechanism such as a robot (not shown).

For example, a heating apparatus 8 including an infrared heater for drying the frozen particles 35 held in the tray 7 is provided in the drying chamber 3. Moreover, a cold trap 6 connected to the freezer (not shown) is provided in the drying chamber 3. The cold trap 6 promotes drying of the frozen particles in the tray 7 by adsorbing moisture sublimed from the frozen particles 35 heated by the heating apparatus 8 in a vacuum.

The raw material liquid includes a solvent or dispersion medium and a solute dissolved in the solvent or a dispersoid dispersed in the dispersion medium. In this embodiment, for example, a solvent including water and a solute dissolved in the solvent or a dispersion medium including water and a dispersoid dispersed in the dispersion medium can be used as the raw material liquid. In this case, it is favorable that the concentration of water used as the solvent and the dispersion medium is set to be 70 mass % or more.

It is favorable that viscosity of the solvent or dispersion medium or a composite medium of both is viscosity of pure water or more and viscosity of the raw material liquid is 5 mPa·s or less. That is, in this embodiment, a liquid including a solvent or dispersion medium including water having viscosity of 5 mPa·s or less and a solute dissolved in this solvent or a dispersoid dispersed in this dispersion medium can be favorably used as the raw material liquid. Examples of the solute or dispersoid can include raw materials of freeze-dry foods the cells of which are not damaged and the protein and other constituent elements of which are not deteriorated at the time of vacuum freeze-drying, medicines (chemicals) that are active ingredients in pharmaceutical production, and the like.

[Vacuum Freeze-Drying Method]

Subsequently, a vacuum freeze-drying method for the raw material liquid using the vacuum freeze-drying apparatus 1 configured in the above-mentioned manner will be described.

In this embodiment, for producing a freeze-dried powder, first of all, the vacuum evacuation apparatus 10 and the cold trap 5 are activated in a state in which the gate valve 4 is closed, to thereby reduce the internal pressure of the freezing chamber 2. Then, the cold trap 5 and the injection nozzle 20 are activated to thereby inject the raw material liquid from an end portion of the injection nozzle 20.

As shown in FIG. 1, the raw material liquid injected from the injection nozzle 20 becomes a columnar raw material liquid 21 in an injection initial state. After that, it is sequentially separated from the columnar raw material liquid 21 due to changes in surface tension inherent in the columnar raw material liquid 21 and becomes droplets of the raw material liquid 30. It should be noted that because of the separation due to the surface tension, in the deformation into a spherical shape from a columnar, i.e., cylindrical shape, it changes into balls (droplets 31) having a diameter larger than a cylinder diameter (approximately equal to the hole diameter of the nozzle hole 203) at the time of initial injection.

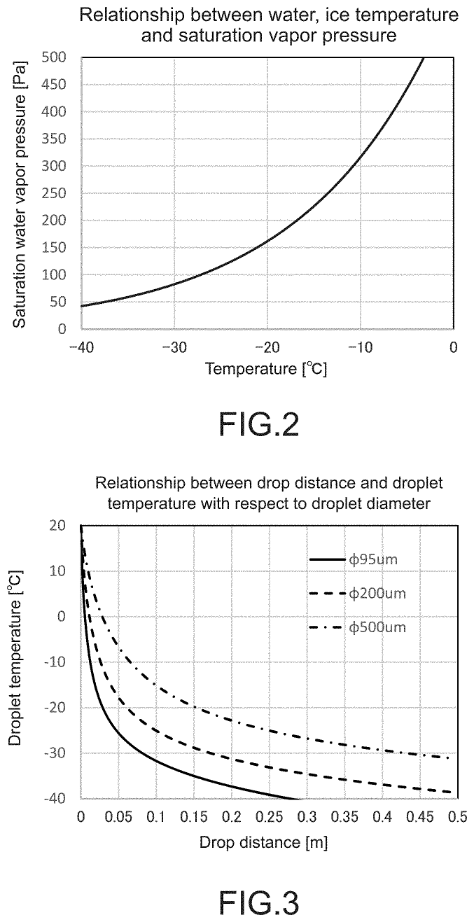

In addition, this raw material liquid is influenced by a water vapor partial pressure in the freezing chamber 2, which is exhausted and controlled primarily through the cold trap 5, when the raw material liquid travels after it is injected into the freezing chamber 2 (e.g., based on the relationship in FIG. 2). The raw material liquid remains in the liquid phase in the entire region until it changes from the columnar, i.e., cylindrical shape into the spherical shape (in a range of droplets 30). However, an increase in specific surface area also serves as synergy, and due to the phenomenon where that water vaporizes from the surfaces of the droplets 30, heat is removed from the droplets 30 (due to heat transfer associated with phase transition). Then, mainly due to this cause, surface layers of the droplets 30 reach a self-freezing temperature to start self-freezing through supercooling. After that, the self-freezing rapidly progresses from the surface layers to the centers. The droplets after this process will be referred to as droplets 31. The droplets 31 exhibit a state after supercooling is broken. Since ice crystals of the droplets 31 are growing there, at least the surface layer temperature of the droplets 31 can be close to the triple point of water. Then, it gets closer to the temperature based on the water vapor partial pressure in the freezing chamber 2.

It should be noted that since it is said that the self-freezing temperature of pure water is −40° C. and the raw material liquid is not pure water, it is unnecessary to cool the raw material liquid below this temperature. That is, since the raw material liquid typically has a self-freezing temperature higher than −40° C., it is sufficient to maintain the freezing chamber 2 at a water vapor partial pressure corresponding to that temperature. For example, by setting the water vapor partial pressure in the freezing chamber 2 to be 50 Pa or less, it is possible to sufficiently cause the droplets 30 to have the self-freezing temperature, though not limited thereto. A water vapor partial pressure higher than 50 Pa may be set depending on the kind of raw material liquid.

Alternatively, a crystal nucleus production temperature (for self-freezing) may be experimentally determined for each raw material liquid and a saturation vapor pressure value corresponding to the production temperature, i.e., the water vapor partial pressure in the freezing chamber 2 may be determined. It should be noted that because of the cooling method for the droplets 30 using heat removal utilizing the phase transition of water, it is desirable to set the water vapor partial pressure to be 50 Pa or less in order to realize a cooling velocity to be described later. It is thus possible to freeze the solute or dispersoid of the raw material liquid at such a speed that cells are not broken and protein and other constituent elements are not deteriorated at the time of vacuum freeze-drying. In this case, it is sufficient to determine a lower limit value of the water vapor partial pressure not to exceed 50 Pa due to an increase in pressure (water vapor partial pressure) at the time of injection. That is, it is sufficient to calculate or experimentally determine a value depending on the exhaust capability of the apparatus.

The self-freezing of the droplets 31 progresses during the travel and at least surface layers of the droplets 31 all are transformed into the solid phase. Accordingly, frozen particles 32 are formed. After changing into these frozen particles 32, the frozen particles 32 land on the tray 7 as collected frozen particles 35. Here, if the surface layers of the droplets 30 have not all been transformed into the solid phase, the droplets 30 are different in rebounding at the time of landing (in a case where most of the droplets are in the liquid phase, determination can be easily performed because the rebounding coefficient is very smaller than a case where most of the droplets are in the solid phase), and determination as to whether they are in the unfrozen state or in the state of the frozen particles 32 can be performed also in image analysis using a camera to be described later (in a case where it can be confirmed that the droplets have rebounded to a certain height or more, it is determined that the droplets are in the frozen state). Moreover, in a case where the surface layers are in the liquid phase, the frozen particles 32 are coupled with each other, and therefore the determination can also be performed by checking it.

It should be noted that although the raw material liquid injected from the injection nozzle 20 does not have constantly the same injection direction (directivity) due to surface tension and the like in some cases, setting the injection direction to be the same direction as the gravitational acceleration and forming a gas flow of water vapor to be adsorbed by the cold trap 5 can improve the directivity and cause the frozen particles 32 to drop in a state in which the spread of the frozen particles 32 is limited within the range of the tray 7 and hold them.

Moreover, the shape of the frozen particles 35 is typically a spherical shape, though the shape of the frozen particles 35 may have various shapes such as an ellipse shape and a fusiform shape. The shape of the frozen particles 35 is determined depending on, for example, a nozzle hole diameter, an injection flow rate (or an injection pressure), an injection initial velocity, a travel time (drop time), viscosity of the raw material liquid, and the like. Therefore, the frozen particles 35 in a desired shape can also be generated by adjusting these conditions.

After that, the tray 7 is conveyed into the drying chamber 3 where the pressure is reduced by the vacuum evacuation apparatus 14 in advance, through the conveying mechanism such as the robot (not shown). The heating apparatus 8 heats the frozen particles 35 on the tray 7 in a vacuum to sublime the ice remaining in the frozen particles 35, to thereby dry the frozen particles 35. The cold trap 6 adsorbs moisture sublimed from the frozen particles 35.

It should be noted that the step of drying the frozen particles 35 in the drying chamber 3 is performed in a state in which the gate valve 4 is closed. Accordingly, the freezing chamber 2 is separated from the drying chamber 3 in terms of the atmosphere, and therefore the subsequent steps of injecting, freezing, and drying the raw material liquid can be continuously carried out in the freezing chamber 2.

(Assessment and Adjustment of Frozen Particles)

The vacuum freeze-drying method according to this embodiment includes an assessment step of assessing the frozen particles 35 held in the tray 7. In this assessment step, the frozen particles 35 are assessed in view of whether or not the particles held in the tray 7 are the frozen particles 35 or whether the maximum diameter of the frozen particles 35 held in the tray 7 is equal to or smaller than a predetermined value.

The assessment method is not particularly limited, and, for example, images or the like of the camera (not shown) that images a matter held in the tray 7 or particles dropping toward the tray 7 may be used. The camera is, for example, installed at a position capable of imaging the interior of the freezing chamber 2 through an observation window 17 provided at a predetermined position in the freezing chamber 2. By processing the images of the camera, whether or not the particles on the tray 7 are the frozen particles 35 or whether the maximum diameter of the frozen particles 35 is equal to or smaller than the predetermined value can be assessed.

The predetermined value is determined in accordance with the volume of droplets or particles of the raw material liquid or the specific surface area. In this embodiment, the predetermined value is magnitude that can freeze the entire surface region in a travel distance of 1 m or less, and specifically, for example, 200 μm or less, more favorably, 95 μm or less as will be described later.

The vacuum freeze-drying method according to this embodiment further includes an adjustment step of adjusting the injection flow rate of the raw material liquid from the injection nozzle 20 or the properties of the injection nozzle 20 such that frozen particles having a maximum diameter of 200 μm or less are generated when it is assessed as a result of the assessment step that the maximum diameter of the generated frozen particles 35 exceeds 200 μm or the droplets of the raw material liquid are unfrozen. In this adjustment step, adjustment or the like of the injection initial velocity (injection pressure) of the raw material liquid from the injection nozzle 20 and the hole diameter of the injection nozzle 20 is performed under a condition where the injection initial velocity of the raw material liquid from the injection nozzle is 6 m/s or more and 33 m/s or less.

[Regarding Maximum Diameter of Frozen Particles]

In this specification, the maximum diameter of the frozen particles 35 (or the maximum droplet diameter) refers to a value obtained by adding twice a standard deviation determined conforming to JIS Z8819-2 to a mean particle diameter determined conforming to JIS Z8819-2.

Alternatively, the maximum diameter may be a droplet diameter of the frozen particles 32 travelling, which has been measured on the basis of an image captured by the camera.

As a method of measuring the maximum diameter of the frozen particles 32 in this case, in accordance with an image analysis method conforming to JIS Z8827-1, sampling is performed using a droplet diameter perpendicular to the injection direction (travelling direction) as a Feret diameter and a group of particle diameter samples is created. Accordingly, there is an advantage that a high speed frame rate corresponding to the injection initial velocity of the raw material liquid is unnecessary. The number of samples is not particularly limited as long as a statistically significant number of samples can be ensured. For example, the number of samples is 200.

Subsequently, with respect to the created group of samples, a mean particle diameter and a standard deviation are determined conforming to JIS Z8819-2, and a value obtained by adding twice the standard deviation to this mean particle diameter is set as the maximum diameter of the frozen particles 32.

It should be noted that the maximum diameter measurement is not limited to the example in which it is performed in the on-line step, and it may be performed in an off-line step. In this case, for example, a matter (dry particles) obtained by drying the frozen particles 35 can be set as a measurement target. A gravitational liquid sedimentation method, a method by the mass of sediment-particles in liquid, a centrifugal liquid sedimentation method, or the like can be used as the measurement method other than the above-mentioned method. Alternatively, utilizing a measurement value obtained in the off-line step, a correction coefficient to be multiplied on the calculated value of the maximum diameter according to the image analysis method may be generated. Accordingly, the accuracy of the on-line measurement can be improved.

[Generation Condition of Frozen Particles]

The vacuum freeze-drying apparatus 1 according to this embodiment is configured to be capable of injecting the raw material liquid from the injection nozzle 20 inside the freezing tank 2 and generating frozen particles by self-freezing at a height position of 1 m or less from the injection nozzle 20. In particular, in a case where a raw material liquid including a solvent or dispersion medium including water having viscosity of 5 mPa·s or less is injected from the injection nozzle 20, the frozen particles 35 are generated under a condition as follows in order to make a distance in which particles are frozen shorter than that of the conventional technology.

(Water Vapor Partial Pressure in Freezing Chamber)

When the raw material liquid is injected from the injection nozzle 20, the pressure inside the freezing chamber 2 rises. Therefore, on the basis of data or the like measured by the vacuum gauge 11 in advance, the water vapor partial pressure in the freezing chamber 2 at the time of injection of the raw material liquid is adjusted. In this embodiment, the exhaust amount of the freezing chamber 2 is adjusted such that the water vapor partial pressure in the freezing chamber 2 is maintained at 50 Pa or less.

FIG. 2 is a graph showing a relationship between the saturation water vapor pressure to the temperature of water or ice. Alternatively, a relationship between the saturation water vapor pressure to water or ice, which is determined conforming to JIS Z8806, may be used.

As shown in FIG. 2, in a case where the water vapor partial pressure in the freezing chamber 2 is 50 Pa or less, the droplet temperature of water injected from the injection nozzle 20 is about −40° C. As a result, the droplets of the raw material liquid including water reliably reach the self-freezing temperature. In this embodiment, the exhaust amount is adjusted by the exhaust amount adjustment apparatus 13 and the cold trap 5 on the basis of the result obtained by the vacuum gauge 11 such that the water vapor partial pressure in the freezing chamber 2 is maintained at 50 Pa or less.

It should be noted that also in a case where droplets formed of water have a large diameter, the relationship shown in FIG. 2 barely change. It should be noted that as the droplet diameter becomes larger, the cooling time for obtaining the predetermined temperature becomes longer, and therefore the travel distance in which droplets are cooled and reach −25° C. becomes longer. It is because the volume of droplets increases in view of the specific surface area.

(Droplet Diameter of Raw Material Liquid)

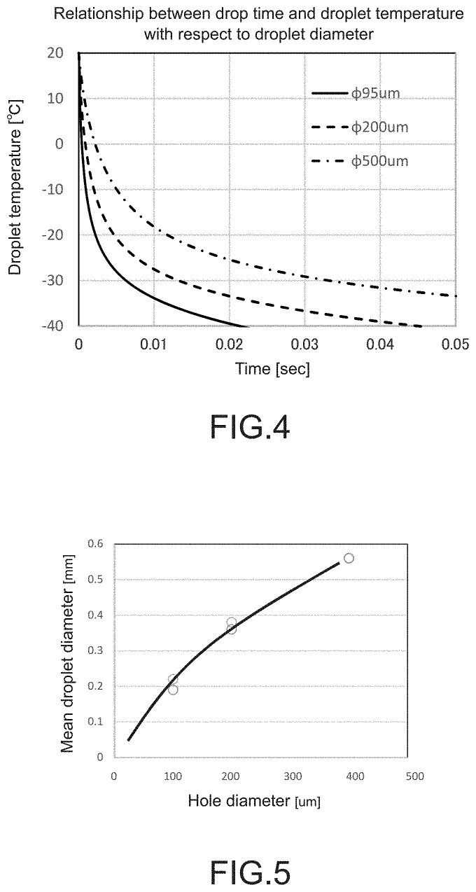

FIG. 3 is a graph calculating a relationship between a drop distance that is a travel distance with respect to a droplet diameter and a droplet temperature in a case where the water vapor partial pressure in the freezing chamber 2 is maintained at 50 Pa, pure water is injected in the gravitational acceleration direction at an initial velocity of 13 m/s from the injection nozzle 20, and droplets are formed. FIG. 4 is a graph calculating a relationship between a droplet drop time and the droplet temperature under the same condition.

It should be noted that the droplet diameter set forth herein means a droplet maximum diameter. The droplet diameter can be typically adjusted through the hole diameter of the injection nozzle 20.

As shown in FIG. 3, in a case where the droplet diameter is 500 μm (in the figure, a graph shown as the long dashed short dashed line), a drop distance of 250 mm or longer is necessary for the droplet temperature to reach −25° C. Meanwhile, it can be seen that in a case where the droplet diameter is 95 μm (in the figure, a graph shown as the solid line), the droplet temperature reaches −25° C. in a drop distance of about 50 mm and droplets are frozen.

Moreover, as it can be seen from FIG. 4, as the droplet diameter becomes smaller, the temperature decrease speed (cooling velocity) increases. For example, in the cooling process from 20° C. to −25° C., the cooling velocity in a case where the droplet diameter is 200 μm is about 5900° C./s and the cooling velocity in a case where the droplet diameter is 95 μm is about 12000° C./s. That is, for generating frozen particles having a maximum diameter of 200 μm or less, the cooling velocity from 20° C. to −25° C. in a case where the injection initial velocity of the raw material liquid is 13 m/s is 5900° C./s or more. It is a cooling velocity at which the solute or dispersoid of the raw material liquid is hardly deteriorated. That is, if the injection flow rate of the raw material liquid from the injection nozzle 20 or the properties of the injection nozzle 20 are adjusted to realize such a cooling velocity, the solute or dispersoid of the raw material liquid can be frozen at such a speed that cells are not broken and protein and other constituent elements are not deteriorated at the time of vacuum freeze-drying.

Therefore, if the droplet diameter of the raw material liquid injected from the injection nozzle 20 is 200 μm or less, more favorably, 95 μm or less, the droplet freezing speed that does not deteriorate the solute or dispersoid can be maintained and the drop distance can be reliably shortened.

[Adjustment Method for Droplet Diameter]

In this embodiment, in order to adjust the magnitude of the droplet diameter, it is sufficient to adjust, for example, the nozzle hole diameter (hole diameter) of the injection nozzle 20 that injects the raw material liquid. FIG. 5 is a graph showing a relationship between the hole diameter of the injection nozzle 20 and the mean droplet diameter.

As shown in FIG. 5, the mean droplet diameter greatly depends on the hole diameter of the injection nozzle 20. Typically, the mean droplet diameter takes a value larger than the hole diameter as described above.

It should be noted that the droplet diameter has a distribution that differs depending on the injection condition, and some droplets are larger than the mean droplet diameter.

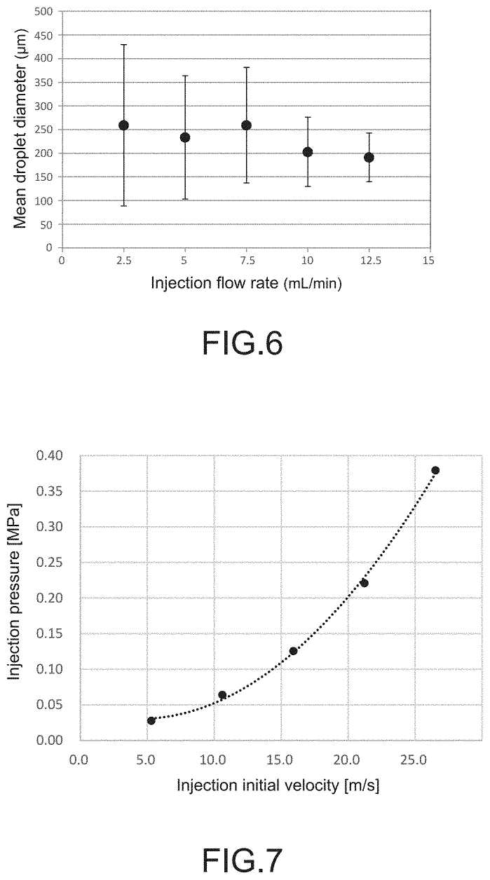

FIG. 6 is a graph showing plus or minus twice the mean droplet diameter and the standard deviation of droplets formed when pure water is injected at various injection flow rates from the injection nozzle having a hole diameter of 100 μm, as an error bar.

It should be understood that in a case where a value obtained by adding twice the standard deviation to the mean droplet diameter is set as the maximum droplet diameter, although it differs depending on the injection condition, the maximum droplet diameter is twice to five times as large as the nozzle diameter.

As described above, in a case where the droplet diameter formed by injecting a raw material liquid from the injection nozzle 20 is 200 μm or less, more favorably 95 μm or less, the droplet freezing speed that does not deteriorate the solute or dispersoid can be maintained and the drop distance can be reliably shortened.

Therefore, in a case where the hole diameter of the injection nozzle 20 is set to be 40 μm, for example, the maximum droplet diameter can be set to be 200 μm or less. Accordingly, the droplet freezing speed that does not deteriorate the solute or dispersoid can be maintained and the drop distance can be reliably shortened. It should be noted that depending on the injection condition, the maximum droplet diameter can also be set to be 95 μm also in a case where the hole diameter of the injection nozzle 20 is set to be 50 μm.

In this embodiment, the injection initial velocity of the raw material liquid injected from the injection nozzle 20 is adjusted to be 6 m/s or more and 33 m/s or less.

The inventors of the present invention had empirically found that if the injection initial velocity of the raw material liquid is higher than 33 m/s even in a case where the hole diameter of the injection nozzle is set to be 50 μm, droplets arrive at the tray 7 before they are completely frozen. It should be noted that with a nozzle having a hole diameter of 100 μm or more, even if control is performed such that the injection initial velocity of the raw material liquid is 23 m/s, the drop distance necessary for freezing is 1 m or more.

On the other hand, in a case where the injection initial velocity of the raw material liquid is lower than 6 m/s, there is a disadvantage that the injection nozzle hole is easily closed because the raw material liquid is frozen in the injection nozzle hole or the raw material liquid cannot blow away a dry matter fixed near the nozzle outlet. By setting the injection initial velocity of the raw material liquid to be 6 m/s or more, it is possible to blow away a raw material liquid at a temperature of 0° C. or more and at room temperature or less near the injection portion of the injection nozzle hole before the raw material liquid transitions to the solid phase and grows, and to prevent the nozzle hole from being closed.

FIG. 7 is a graph showing a relationship between the injection pressure of the raw material liquid in the injection nozzle 20 and the injection initial velocity. This graph is data showing a result in a case of adding force greater than the surface tension of the raw material liquid to a raw material liquid in the nozzle hole 203 having a hole diameter of 100 μm and a length of 0.5 mm.

Although the injection pressure that accomplishes a desired injection initial velocity differs depending on the hole diameter and hole shape of the nozzle hole 203, if the raw material liquid supply amount adjustment apparatus 12 adjusts the supply amount (liquid delivery pressure) of the raw material liquid with respect to the injection nozzle 20, 6 m/s or more and 33 m/s or less of the injection initial velocity of the raw material liquid from the injection nozzle 20 can be accomplished.

For example, in a case where the viscosity of the raw material liquid is substantially equal to viscosity of water, the injection pressure that realizes the injection initial velocity of 6 m/s or more and 33 m/s or less is 0.03 MPa or more and 0.6 MPa or less.

On the other hand, in a case of a raw material liquid having viscosity higher than the viscosity of water, a higher injection pressure is necessary. For example, in a case where a solution having viscosity of 5 mPa·s is injected with the injection nozzle 20 having a hole diameter of 50 the injection pressure is 0.05 MPa or more and 0.7 MPa or less.

In view of the above, in the vacuum freeze-drying apparatus 1 according to this embodiment, the raw material liquid supply amount adjustment apparatus 12 is configured to be capable of adjusting the injection pressure of the raw material liquid from the injection nozzle 20 in a range of 0.03 MPa or more and 0.7 MPa or less.

It should be noted that instead of or in addition to the adjustment of the injection pressure, the hole diameter and shape of the nozzle hole of the injection nozzle 20 may be adjusted, the injection nozzle 20 may be heated at a predetermined temperature, or vibration may be applied to the injection nozzle 20 as appropriate. The injection flow rate of the raw material liquid can also be optimized by changing the nozzle hole properties in this manner.

When the raw material liquid is injected under the above-mentioned condition, for example, as shown in FIG. 1, the raw material liquid injected from the injection nozzle 20 becomes the columnar raw material liquid 21 in an injection initial state. After that, it is separated from the columnar raw material liquid 21 due to the surface tension and becomes the droplets 30 in a drop shape (fusiform shape).

In addition, as described above, these droplets of the raw material liquid 30 become the droplets 31 when the surface layers start self-freezing, become granular droplets 32 at least the surface layers of which are frozen, and finally become the frozen particles 35 which are entirely or almost entirely frozen.

These frozen particles 35 are held in the tray 7.

According to this embodiment described above, in a state in which the water vapor partial pressure in the freezing chamber 2 is maintained at 50 Pa or less, adjustment is performed such that the maximum diameter of the frozen particles 35 is 200 μm or less, favorably 95 μm or less and that the injection initial velocity of the raw material liquid is 6 m/s or more and 33 m/s or less, and the frozen particles 35 of the raw material liquid can be produced in a shorter travel distance (1 m or less) for a shorter time as compared to the conventional technology. Accordingly, the vacuum freeze-drying apparatus 1 that is compact and capable of mass production can be provided.

### EXAMPLES

Using a micro powder freeze-drying apparatus manufactured by ULVAC, Inc., “Micropowderdry (trademark) System”, the tray 7 was installed at a height of 1 m directly below the injection nozzle 20, and the water vapor partial pressure in the freezing chamber 2 was maintained at 50 Pa or less, and the following experiments were conducted.

### Example 1

When generation of frozen particles was attempted after injecting an albumin solution (7 wt %) as the raw material liquid from the injection nozzle having a hole diameter of 50 μm under a predetermined condition, results shown in Table 1 were obtained.

It should be noted that for the purpose of stabilizing the injection of the raw material liquid, only 0.5 ml of raw material liquid was injected at an injection flow rate of 10.0 ml/min at the time of injection start, and then the injection was continued at a target injection flow rate.

The injection flow rate was set to be an arbitrary value through a syringe pump. The injection initial velocity was calculated on the basis of the injection flow rate and the nozzle hole diameter.

TABLE 1

| | | | Injection | |
|---|---|---|---|---|
| | Nozzle hole | Injection | initial | |
| Raw material | diameter | flow rate | velocity | |
| liquid | (μm) | (ml/min) | (m/s) | Results |
| Albumin | 50 | 1.0 | 8.5 | Nozzle outlet was |
| solution | | | | closed by freezing |
| (7 wt %) | | 1.5 | 13 | No problem |
| | | 2.5 | 21 | Some droplets were |
| | | | | unfrozen |

Under a condition where the injection flow rate was 1.5 ml/min (injection initial velocity of 13 m/s), it was confirmed that frozen particles having a maximum diameter of about 200 μm were generated.

On the other hand, under a condition where the injection flow rate was 1.0 ml/min (injection initial velocity of 8.5 m/s), it was confirmed that the raw material liquid was frozen at the outlet of the injection nozzle and the nozzle hole was closed.

Moreover, under a condition where the injection flow rate was 2.5 ml/min (injection initial velocity of 21 m/s), it was confirmed that there were unfrozen droplets on the tray 7.

In view of this, when the injection initial velocity was adjusted at 17 m/s by adjusting the injection flow rate, it was confirmed that frozen particles having a maximum diameter of about 200 μm or less were generated.

### Example 2

When generation of frozen particles was attempted by injecting an albumin solution (5 wt %) as the raw material liquid from the injection nozzle having a hole diameter of 50 μm under a predetermined condition, results shown in Table 2 were obtained.

TABLE 2

| | | | Injection | |
|---|---|---|---|---|
| | Nozzle hole | Injection | initial | |
| Raw material | diameter | flow rate | velocity | |
| liquid | (μm) | (ml/min) | (m/s) | Results |
| Mannitol | 50 | 0.5 | 4.2 | Unfrozen droplets |
| solution | | | | adhered to inner |
| (5 wt %) | | | | wall of freezing tank |
| | | 1.0 | 8.5 | A small amount |
| | | | | of frozen matter |
| | | | | adhered to nozzle |
| | | | | outlet |
| | | 4.0 | 34 | Some droplets were |
| | | | | unfrozen |

Under a condition where the injection flow rate was 1.0 ml/min (injection initial velocity of 8.5 m/s), it was confirmed that a small amount of frozen matter adhered to the nozzle outlet while it was confirmed that frozen particles having a maximum diameter of about 100 μm were generated.

On the other hand, under a condition where the injection flow rate was 0.5 ml/min (injection initial velocity of 4.5 m/s), it was confirmed that a frozen matter adhered to the nozzle outlet, the frozen matter greatly bent the injection direction, and unfrozen droplets adhered to the inner wall surface of the freezing tank.

Moreover, under a condition where the injection flow rate was 4.0 ml/min (injection initial velocity of 34 m/s), it was confirmed that there were unfrozen droplets on the tray 7.

In view of this, when the injection initial velocity was adjusted at 25 m/s by adjusting the injection flow rate, it was confirmed that frozen particles having a maximum diameter of about 100 μm were generated.

### Example 3

When generation of frozen particles was attempted by injecting a mannitol solution (5 wt %) as the raw material liquid under a predetermined condition from the injection nozzle having a hole diameter of 100 μm, results shown in Table 2 were obtained.

TABLE 3

| | | | Injection | |
|---|---|---|---|---|
| | Nozzle hole | Injection | initial | |
| Raw material | diameter | flow rate | velocity | |
| liquid | (μm) | (ml/min) | (m/s) | Results |
| Mannitol | 100 | 1.0 | 2.1 | A small amount |
| solution | | | | of frozen matter |
| (5 wt %) | | | | adhered to nozzle |
| | | | | outlet |
| | | 2.0 | 4.2 | Unfrozen droplets |
| | | | | adhered to inner |
| | | | | wall of freezing tank |
| | | 3.0 | 6.4 | No problem |
| | | 6.0 | 21 | Some droplets were |
| | | | | unfrozen |

Under a condition where the injection flow rate was 3.0 ml/min (injection initial velocity of 6.4 m/s), it was confirmed that frozen particles having a maximum diameter of about 200 μm were generated.

On the other hand, under a condition where the injection flow rate was 1.0 ml/min (injection initial velocity of 2.1 m/s), it was confirmed that the raw material liquid was frozen at the outlet of the injection nozzle and the nozzle hole was closed.

Moreover, under a condition where the injection flow rate was 2.0 ml/min (injection initial velocity of 4.2 m/s), it was confirmed that a frozen matter is adhered to the nozzle outlet, the frozen matter greatly bent the injection direction, and unfrozen droplets adhered to the inner wall surface of the freezing tank.

In addition, under a condition where the injection flow rate was 6.0 ml/min (injection initial velocity of 21 m/s), it was confirmed that there were unfrozen droplets on the tray 7.

In view of this, when the injection initial velocity was adjusted at 11 m/s by adjusting the injection flow rate, it was confirmed that frozen particles having a maximum diameter of about 200 μm or less were generated.

It should be noted that the above-mentioned embodiment can be carried out by modifying it as follows.

For example, in the above-mentioned embodiment, the raw material liquid is injected from the injection nozzle 20 in the gravitational acceleration direction inside the freezing chamber 2, though the present invention is not limited thereto. For example, a configuration in which the raw material liquid is injected in a direction opposite to the gravitational acceleration direction, i.e., a configuration in which the raw material liquid is reduced in velocity rather than being increased in velocity from the injection initial velocity due to the gravitational acceleration may be employed. In this case, it is possible to ensure a stay time equivalent to the drop time shown in FIG. 4 and subtract the gravitational acceleration influence from the drop distance shown in FIG. 3. As a result, the travel distance of droplets of the raw material liquid is shorter and a more compact vacuum freeze-drying apparatus can be realized.

Moreover, even in a situation where the properties of the injection nozzle are adjusted such that frozen particles having a maximum diameter of 200 μm or less are generated, for example, in a case where it is desirable to make a distribution of values of circularity of respective frozen particles closer to 1 (e.g., a case where it is desirable that the particle-size distribution be within a desired dispersion range as a normal distribution centered at a perfect sphere), adjustment of the distribution state of the circularity can also be performed by performing a check similar to that of FIG. 6. In general, it is considered that as the time in which the state of the droplets 31 is maintained becomes longer, the change from the fusiform shape into the perfect spheric shape can be performed due to the surface tension and vibrations of the surface layers converge more easily. Therefore, the adjustment can be performed on the basis of a relationship between the injection initial velocity and the specific surface area. That is, a method in which the range of the injection initial velocity or the injection pressure is further limited may be used. For example, the above-mentioned adjustment can be realized by dividing such a range into two ranges, selecting either of the ranges through the above-mentioned check, and using the selected range.

Moreover, in the above-mentioned embodiment, the freezing chamber 2 and the drying chamber 3 are connected to each other via the gate valve 4, though the present invention is not limited thereto. A heating apparatus that dries frozen particles in a single vacuum chamber can be provided.

It should be noted that in this case, in order to maintain the water vapor partial pressure at 50 Pa or less while the liquid is injected, it is favorable to employ a configuration to maintain the tray that holds frozen particles during injection at a low temperature and reduce the amount of sublimed gas generated from the frozen particles.

Moreover, in the above-mentioned embodiment, the cold traps 5 and 6 are provided in the freezing chamber 2 and the drying chamber 3, respectively, though the present invention is not limited thereto. A configuration in which the cold trap is disposed in a chamber different from the freezing chamber and the drying chamber and this chamber and the freezing chamber are connected to each other may be employed.

In this case, a plurality of cold traps may be connected to the freezing chamber and the drying chamber, respectively, and the amount of working in which a continuous operation can be performed may be further increased by repeating a step of switching one of the cold traps to another one to continuously operate instead of it when moisture that the one of the cold traps can adsorb reaches the upper limit and simultaneously removing the moisture adsorbed by the cold trap used until that time.

### Second Embodiment

Subsequently, a second embodiment of the present invention will be described. In this embodiment, a configuration of the injection nozzle will be described in detail.

FIG. 9 is a cross-sectional view showing an example of a cross-sectional structure in an injector 41 for a vacuum freeze-drying apparatus according to this embodiment. Hereinafter, configurations different from those of the first embodiment will be mainly described, and configurations similar to those of the first embodiment will be denoted by similar reference signs and descriptions thereof will be omitted or simplified.

As shown in FIG. 9, the injector 41 includes an introduction pipe 42, an injection nozzle 43, and a fixation ring 44. The introduction pipe 42 is fixed to an upper surface of the freezing chamber 2. A raw material liquid is received in an inner space 42S of the introduction pipe 42 from the raw material liquid supply amount adjustment apparatus 12. The introduction pipe 42 introduces the raw material liquid received from the raw material liquid supply amount adjustment apparatus 12 into the injection nozzle 43. The introduction pipe 42 may have a cylindrical shape or may have a polygonal pipe shape. An end portion of the introduction pipe 42 may include a support ring 42A for supporting the injection nozzle 43.

The injection nozzle 43 injects a raw material liquid introduced from the introduction pipe 42 into an inner space of the freezing chamber 2. The injection nozzle 43 has an injection hole 51 that penetrates between the inner space of the introduction pipe 42 and the inner space of the freezing chamber 2 (the injection hole 51 corresponds to the nozzle hole 203 in the first embodiment). Regarding the number of injection holes 51, one injection hole 51 may be provided for each introduction pipe 42 or two or more injection holes 51 may be provided for each introduction pipe 42. The injection nozzle 43 may have a plate shape or may have a tubular shape with a bottom portion including the injection hole 51.

The injection nozzle 43 may be sandwiched by the support ring 42A and the fixation ring 44 such that the injection hole 51 is opened to the inner space of the freezing chamber 2, may be supported only by the introduction pipe 42, or may be configured integrally with the introduction pipe 42. In a case where the injection nozzle 43 is sandwiched by the support ring 42A and the fixation ring 44, the support ring 42A and the fixation ring 44 may be fixed by a clamping member 45. In a case where the injection nozzle 43 is connected to the support ring 42A, a sealing member such as an O-ring may be interposed between the support ring 42A and the injection nozzle 43.

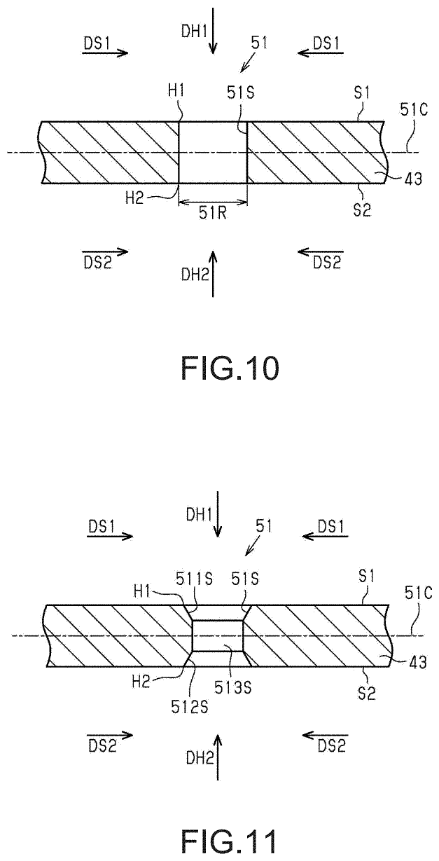

As shown in FIG. 10, the injection nozzle 43 has an inflow surface S1 and an injection surface S2. The inflow surface S1 is a surface in which the injection hole 51 is opened, and is a surface that faces the inner space of the introduction pipe 42 in the injection nozzle 43. The inflow surface S1 may be a flat surface such as a horizontal surface or may be a curved surface. The inflow surface S1 may a convex curved surface that protrudes toward the inner space of the introduction pipe 42 or may be a convex curved surface that protrudes toward the injection surface S2.

The injection surface S2 is a surface in which the injection hole 51 is opened and is a surface that is exposed to the inner space of the freezing chamber 2 in the injection nozzle 43. The injection surface S2 may be a surface that faces the tray 7 or may be a surface that faces a member other than the tray 7 in the inner space of the freezing chamber 2. The injection surface S2 may be a flat surface such as a horizontal surface or may be a curved surface. The injection surface S2 may a convex curved surface that protrudes toward the inner space of the freezing chamber 2 or may be a convex curved surface that protrudes toward the inflow surface S1.

The injection hole 51 penetrates between the inflow surface S1 and the injection surface S2. The injection hole 51 may be a circular hole that extends toward the injection surface S2 from the inflow surface S1 and has a constant diameter. A hole inner surface 51S of the injection hole 51 is a surface that defines the injection hole 51 with respect to a set of the inflow surface S1, the injection surface S2, and the injection nozzle 43. In a case where the injection hole 51 is a circular hole, the hole inner surface 51S of the injection hole 51 is a cylindrical surface that extends toward the injection surface S2 from the inflow surface S1. An inner diameter 51R of the injection hole 51 influences the thickness of the columnar raw material liquid (hereinafter, also referred to as liquid column) 21, and thus the size of the droplets 31. The inner diameter 51R of the injection hole 51 is selected as appropriate in accordance with the size of the frozen particles 32. The inner diameter 51R of the injection hole 51 may be, for example, 0.02 mm or more and 0.5 mm or less. Moreover, the length of the injection hole 51, which is a distance between the inflow surface S1 and the injection surface S2, functions as a resistance for a fluid, and influences the thickness of the liquid column 21, and thus the size of the droplets 31 and a distribution of particle diameters. Since the shape of the liquid column 21 can be stabilized, it is generally favorable to set the resistance for the fluid to be lower, and the length of the injection hole 51 may be set to be several mm, for example.

As shown in FIG. 11, the injection hole 51 may be constituted by a truncated cone hole that extends toward the injection surface S2 from the inflow surface S1, a truncated cone hole that extends toward the inflow surface S1 from the injection surface S2, and a circular hole that connects each truncated cone hole. In this case, the hole inner surface 51S of the injection hole 51 may be constituted by a first frustum tube surface 511S, a second frustum tube surface 512S, and a cylindrical surface 513S. The first frustum tube surface 511S extends toward the injection surface S2 from the inflow surface S1, using an inflow port H1 as the bottom portion. The second frustum tube surface 512S extends toward the inflow surface S1 from the injection surface S2, using an injection port H2 as the bottom portion. The single cylindrical surface 513S has a constant diameter and couples a top portion of a frustum tube surface 511S with a top portion of a frustum tube surface 512S.

Alternatively, the injection hole 51 may be constituted by a truncated cone hole that extends toward the injection surface S2 from the inflow surface S1 and a circular hole that connects the truncated cone hole and the injection surface S2 to each other. In this case, the hole inner surface 51S of the injection hole 51 may be constituted by the first frustum tube surface 511S and one cylindrical surface that extends to the injection surface S2 from the first frustum tube surface 511S. Alternatively, the injection hole 51 may be constituted by a circular hole that extends toward the injection surface S2 from the inflow surface S1 and a truncated cone hole that extends toward the injection surface S2 from the circular hole. In this case, the hole inner surface 51S of the injection hole 51 may be constituted by one cylindrical surface that extends toward the injection surface S2 from the inflow surface S1 and the second frustum tube surface 512S that extends to the injection surface S2 from such a cylindrical surface.

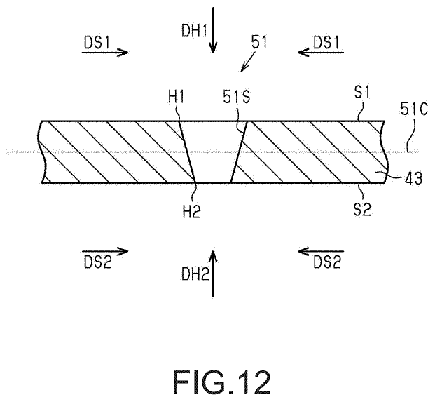

As shown in FIG. 12, the injection hole 51 may be a truncated cone hole that extends toward the injection surface S2 from the inflow surface S1. Alternatively, the injection hole 51 may a truncated cone hole that extends toward the inflow surface S1 from the injection surface S2. In this case, the hole inner surface 51S of the injection hole 51 may be a frustum tube surface that is tapered toward the injection surface S2 from the inflow surface S1 or may be a frustum tube surface that is tapered toward the inflow surface S1 from the injection surface S2.

A boundary between the hole inner surface 51S and the inflow surface S1 is the inflow port H1 that is one opening in the injection hole 51. A boundary between the hole inner surface 51S and the injection surface S2 is the injection port H2 that is the other opening in the injection hole 51. The inflow port H1 is an opening for inputting the raw material liquid into the injection hole 51. The injection port H2 is an opening for outputting the raw material liquid to a vacuum space 21S.

At least one of the inflow surface S1 or the injection surface S2 is a target surface. A surface constituted by the target surface and the hole inner surface 51S includes a region in which a contact angle decreases in a direction of facing the hole inner surface 51S from the target surface. The region in which the contact angle decreases in the direction of facing the hole inner surface 51S from the target surface may be a region in which a contact angle increases in a direction orthogonal to a Y direction.

The region in which the contact angle decreases in the direction of facing the hole inner surface 51S from the target surface guides a raw material liquid flow toward a site having a lower contact angle. A region in which a contact angle increases in a direction orthogonal to the direction of facing the hole inner surface 51S from the target surface also guides a raw material liquid flow in the direction of facing the hole inner surface 51S from the target surface.

The region in which the contact angle decreases in the direction of facing the hole inner surface 51S from the target surface may be a region in which a contact angle decreases by a single step, a region in which a contact angle decreases by multiple steps, or may be a region in which a contact angle decreases continuously. In a case where a contact angle stepwisely decreases, a position that is the boundary of the contact angle may be inside the target surface, may be at a boundary between the target surface and the hole inner surface 51S, or may be inside the hole inner surface 51S.

In a case where the inflow surface S1 is the target surface, the direction of facing the hole inner surface 51S from the target surface is a direction along the inflow surface S1 in (i) the inflow surface S1, or may be a first guide direction DS1 having a direction of facing the inflow port H1 from the outside of the inflow port H1 in the inflow surface S1 as a component. The first guide direction DS1 may be a radial direction of the injection hole 51 or may be a turning direction having the radial direction as the component.

In a case where the inflow surface S1 is the target surface, the direction of facing the hole inner surface 51S from the target surface may be (ii) a direction of entering the hole inner surface 51S from the inflow surface S1. The direction of entering the hole inner surface 51S from the inflow surface S1 is an inflow direction DH1. The inflow direction DH1 is applied to a range from the inflow port H1 in the hole inner surface 51S to a center position 51C of the hole inner surface 51S in the extending direction. The inflow direction DH1 is a direction along the hole inner surface 51S and has a direction of facing the injection port H2 from the inflow port H1 as the component. The inflow direction DH1 may be the extending direction of the injection hole 51 or may be a spiral direction having the extending direction as the component.

In a case where the inflow surface S1 is the target surface, the direction of facing the hole inner surface 51S from the target surface includes the first guide direction DS1 in the inflow surface S1 and may include the inflow direction DH1 in the hole inner surface 51S.

In a case where the injection surface S2 is a target surface, the direction of facing the hole inner surface 51S from the target surface is (iii) a direction along the injection surface S2 in the injection surface S2, and may be a second guide direction DS2 having a direction of facing the injection port H2 from the outside of the injection port H2 in the injection surface S2 as the component. The second guide direction DS2 may be a radial direction of the injection hole 51 or may be a turning direction having the radial direction as the component.

In a case where the injection surface S2 is a target surface, the direction of facing the hole inner surface 51S from the target surface may be (iv) a direction of entering the hole inner surface 51S from the injection surface S2. The direction of entering the hole inner surface 51S from the injection surface S2 is a counter inflow direction DH2. The counter inflow direction DH2 is applied to a range from the injection port H2 in the hole inner surface 51S to the center position 51C of the hole inner surface 51S in the extending direction. The counter inflow direction DH2 is a direction along the hole inner surface 51S and has a direction of facing the inflow port H1 from the injection port H2 as the component. The counter inflow direction DH2 may be the extending direction of the injection hole 51 or may be a spiral direction having the extending direction as the component.

In a case where the injection surface S2 is a target surface, the direction of facing the hole inner surface 51S from the target surface includes the second guide direction DS2 in the injection surface S2 and may include the counter inflow direction DH2 in the hole inner surface 51S.

For example, the injection nozzle 43 shown in FIGS. 10, 11, and 12 may include a region in which a contact angle decreases in a direction of facing the hole inner surface 51S from the inflow surface S1 in at least a part of the inflow port H1 that is a boundary between the inflow surface S1 and the hole inner surface 51S. Alternatively, the injection nozzle 43 may include a region in which a contact angle decreases in the first guide direction DS1 of facing the hole inner surface 51S from the inflow surface S1, in a portion of the inflow surface S1, which is outside of the injection hole 51 with respect to the inflow port H1. Alternatively, the injection nozzle 43 may include the region in which the contact angle decreases in the inflow direction DH1 in a range from the inflow port H1 to the center position 51C in the hole inner surface 51S.

For example, the first frustum tube surface 511S of the injection nozzle 43 shown in FIG. 11 may include the region in which the contact angle decreases in the inflow direction DH1. Alternatively, the injection nozzle 43 may include the region in which the contact angle decreases in the inflow direction DH1 in a range from the boundary between the first frustum tube surface 511S and the cylindrical surface 513S to the center position 51C.

Alternatively, the injection nozzle 43 may include the region in which the contact angle decreases in the inflow direction DH1 at the boundary between the first frustum tube surface 511S and the cylindrical surface 513S. At this time, in the cross-section of the injection nozzle 43 having the center axis of the injection hole 51, an angle of the first frustum tube surface 511S with respect to the cylindrical surface 513S may be larger than a difference value between the contact angle of the first frustum tube surface 511S and the contact angle in the cylindrical surface 513S or may be equal to or smaller than the difference value. For making the raw material liquid flow smoother, it is favorable that the angle of the first frustum tube surface 511S with respect to the cylindrical surface 513S, i.e., an angle formed by the extended surface of the cylindrical surface 513S and the first frustum tube surface 511S, is larger than the difference value between the contact angle of the first frustum tube surface 511S and the contact angle in the cylindrical surface 513S.

For example, the injection nozzle 43 shown in FIGS. 10, 11, and 12 may include a region in which a contact angle decreases in the direction of facing the hole inner surface 51S from the injection surface S2 in at least a part of the injection port H2 that is a boundary between the injection surface S2 and the hole inner surface 51S. Alternatively, the injection nozzle 43 may include a region in which a contact angle decreases in the second guide direction DS2 of entering the hole inner surface 51S from the injection surface S2, in a portion of the injection surface S2, which is outside of the injection hole 51 with respect to the injection port H2. Alternatively, the injection nozzle 43 may include a region in which a contact angle decreases in the counter inflow direction DH2 in a range from the injection port H2 to the center position 51C in the hole inner surface 51S.

For example, the second frustum tube surface 512S of the injection nozzle 43 shown in FIG. 11 may include the region in which the contact angle decreases in the counter inflow direction DH2. Alternatively, the injection nozzle 43 may include the region in which the contact angle decreases in the counter inflow direction DH2 in a range from the boundary between the second frustum tube surface 512S and the cylindrical surface 513S to the center position 51C.

Alternatively, the injection nozzle 43 may include the region in which the contact angle decreases in the counter inflow direction DH2 at the boundary between the second frustum tube surface 512S and the cylindrical surface 513S. At this time, in the cross-section of the injection nozzle 43 having the center axis of the injection hole 51, an angle of the second frustum tube surface 512S with respect to the cylindrical surface 513S may be larger than a difference value between the contact angle in the cylindrical surface 513S and the contact angle of the second frustum tube surface 512S or may be equal to or smaller than the difference value. For making the raw material liquid flow smoother, it is favorable that the angle of the second frustum tube surface 512S with respect to the cylindrical surface 513S, i.e., an angle formed by the extended surface of the cylindrical surface 513S and the second frustum tube surface 512S is larger than the difference value between the contact angle in the cylindrical surface 513S and the contact angle of the second frustum tube surface 512S.

The contact angle is an advancing contact angle of water according to a sessile drop method conforming to JIS R 3257: 1999. The region in which the contact angle decreases in the direction of facing the hole inner surface 51S from the target surface is the region in which the contact angle decreases in the first guide direction DS1, the second guide direction DS2, the inflow direction DH1, and the counter inflow direction DH2.

The region in which the contact angle decreases in each direction DS1, DS2, DH1, or DH2 may be realized by the presence/absence of the surface liquid-repellent layer on the surface of the injection nozzle 43 or may be realized by a difference in liquid-repellent performance in the surface liquid-repellent layer. Alternatively, the region in which the contact angle decreases in each direction DS1, DS2, DH1, or DH2 may be realized by the presence/absence of the surface irregularities structure on the surface of the injection nozzle 43 or may be realized by a difference in flow characteristics in the surface irregularities structure. Alternatively, the region in which the contact angle decreases in each direction DS1, DS2, DH1, or DH2 may be realized by the magnitude of the surface roughness on the surface of the injection nozzle 43. Alternatively, the region in which the contact angle decreases in each direction DS1, DS2, DH1, or DH2 may be realized by the presence/absence of the surface irregularities structure in the surface liquid-repellent layer, may be realized by a difference in flow characteristics with the surface irregularities structure in the surface liquid-repellent layer or may be realized by the magnitude of the surface roughness in the surface liquid-repellent layer.

The surface liquid-repellent layer repels the raw material liquid on the surface of the injection nozzle 43 as compared to the injection nozzle 43 without the surface liquid-repellent layer. The constituent material of the surface liquid-repellent layer is, for example, at least one selected from a group including polytetrafluoroethylene (PTFE), perfluoroalkoxy alkanes (PFA), and fluorinated ethylene-propylene polymers (FEP). The constituent material of the surface liquid-repellent layer is, for example, a plating film codeposited with a water-repellent resin or a zinc-nickel-silica composite plating film subjected to water-repellent silane coupling treatment. It is favorable that the constituent material of the surface liquid-repellent layer includes a fluorine resin because it can provide a high liquid-repellent property. Moreover, it is favorable that the surface liquid-repellent layer is a plating film codeposited with a fluorine resin because it can make the surface liquid-repellent layer mechanically durable. With the plating film codeposited with the fluorine resin, the fluorine resin is easily uniformly distributed into the surface liquid-repellent layer, and the liquid-repellent property due to the fluorine resin and the durability due to the plating film can be obtained uniformly in the entire surface liquid-repellent layer.

The surface liquid-repellent layer is, for example, a nickel plating film codeposited with PTFE. The nickel plating film is, for example, an electroless nickel plating film containing 30% of PTFE. With the electroless nickel plating film, PTFE that is an example of a fluorine resin is easily uniformly distributed into the nickel plating film. Accordingly, the liquid-repellent property of the liquid components is easily uniformly obtained in substantially the entire surface liquid-repellent layer. Moreover, with the nickel plating film, even in a case where the raw material liquid contains a powder or the like, the surface liquid-repellent layer can have wear resistance of the powder.

The surface irregularities structure is strip-like irregularities in each direction DS1, DS2, DH1, or DH2, which are micromachined on the surface of the injection nozzle 43. The surface irregularities structure in the inflow surface S1, the injection surface S2, or the hole inner surface 51S may be vertical slits formed by cutting working such as laser working and water jet cutting. Alternatively, the surface irregularities structure in the inflow surface S1, the injection surface S2, or the hole inner surface 51S may be vertical slits formed by cutting machining such as broaching working, shaping working, and slotter working, grinding machining, or the like. Alternatively, the surface irregularities structure in the hole inner surface 51S may vertical slits formed by discharge machining such as wire electric discharge machining and electrode discharge machining. In addition, the surface irregularities structure in the inflow surface S1, the injection surface S2, or the hole inner surface 51S may be slits formed in the inflow surface S1, the injection surface S2, or the hole inner surface 51S through collision between particles and the surface by repeating preliminary injection using the particles contained in the raw material liquid.

The surface roughness is the size of the irregularities in each direction DS1, DS2, DH1, or DH2, which are machined on the surface of the injection nozzle 43. The surface roughness may be an arithmetic average roughness height, may be a maximum height, or may be a maximum valley depth. The irregularities structure that defines the surface roughness is formed by the machining method described above for the surface irregularities structure.

A relationship between the size of the irregularities of the surface irregularities structure and the size of the irregularities that define the surface roughness and the contact angle differs on the basis of whether the chemical properties of the surfaces with respect to the raw material liquid are liquid-repellent properties or hydrophilic properties.

For example, in a case where the chemical properties of the target surface and the hole inner surface 51S are hydrophilic properties, when the irregularities that constitute the surface irregularities structure and the entire inner portion of the irregularities that define the magnitude of the surface roughness are in contact with the raw material liquid, the surface area with respect to the raw material liquid increases by an amount corresponding to the irregularities and strengthens the wetting property on the surface. That is, in a case where the surface is constituted by enough large irregularities that can hold the entire surface in contact with water, the target surface or the hole inner surface 51S strengthen the wetting property. The surface irregularities structure that extends in each direction DS1, DS2, DH1, or DH2 strengthens the hydrophilic property of having affinity for the raw material liquid and guides the raw material liquid flow in the direction in which irregularities extend.

For example, in a case where the chemical properties of the target surface and the hole inner surface 51S are liquid-repellent properties, when only tip ends of the irregularities that constitute the surface irregularities structure are in contact with the raw material liquid, the surface area with respect to the raw material liquid decreases by an amount corresponding to the irregularities and strengthens the liquid-repellent property on the surface. That is, in a case where the surface is constituted by enough small irregularities that can hold only the tip ends of the convex portions in contact with water, the target surface or the hole inner surface 51S strengthens reduction of the wetting property. Then, the surface irregularities structure that extends in each direction DS1, DS2, DH1, or DH2 strengthens reduction of the wetting property in the direction orthogonal to the Y direction and more strongly guides the raw material liquid flow in the direction in which irregularities extend.

[Actions]

The particle forming method using the above-mentioned injection nozzle includes supplying the injection nozzle 43 with the raw material liquid and injecting the raw material liquid into the vacuum chamber 21 from the injection nozzle 43 to self-dry particles formed of the raw material liquid in the freezing chamber 2.

The raw material liquid supplied into the injector 41 passes through the inflow surface S1 from the introduction pipe 42 and enters the hole inner surface 51S from the inflow port H1. The raw material liquid entering the hole inner surface 51S is injected into the inner space of the freezing chamber 2 from the injection port H2. The raw material liquid injected from the injection port H2 forms the liquid column 21 extending from the injection port H2. Liquid components contained in the liquid column 21 are evaporated in the inner space of the freezing chamber 2 while taking the evaporation latent heat from the raw material liquid and the like, and the liquid column 21 is divided into the droplets 31 having a stable shape due to the surface tension and the like. The droplets 31 from which the evaporation latent heat have been taken off start self-freezing and change into the frozen particles 32. Parts corresponding to the solid phase (solidarized parts) of the liquid components contained in the frozen particles 32 are also evaporated while taking the sublimation latent heat from the raw material or the like. Accordingly, particles of the raw material undergoes self-freezing and the frozen particles 32 that are a freeze-dry matter of the raw material are deposited on the tray 7.

It should be noted that the liquid column 21 and the droplets 31 perform precession motion in vicinity of the injection port H2, and accordingly, the frozen particles 32 are distributed in a cone shape, i.e., are radially distributed in a cross-sectional view. In other words, the precession motion of the liquid column 21 and the droplets 31 changes, during the injection period of the raw material liquid, the position of the liquid column 21 continuous in a straight line shape and the positions of the droplets 31 dotted on the straight line in accordance with a change in the extending direction on the straight line. It indicates that due to both of such precession motion and a flow of a gas that has transitioned into the gas phase, the landing positions of the frozen particles 32 in the tray 7 spread in a constant range. It should be noted that as a result of observing the generation process of the frozen particles 32 using a high-speed camera, the change into the frozen particles 32 from the droplets 31 is only the phase transition from the liquid phase to the solid phase. Moreover, it has been founded that the travelling direction of the frozen particles 32 is a direction following the travelling direction of the droplets 31 and the frozen particles 32 draw trajectories substantially following the law of inertia and then land on the tray 7.

Here, if the raw material liquid stays on the inflow surface S1 or the raw material liquid flow stagnates in the inflow port H1 before the start of injection of the raw material liquid, air-bubbles are mixed in the raw material liquid that flows out from the injection port H2 and pulsation occurs in the raw material liquid that flows out of the injection hole 51. In addition, gas dissolved in the raw material liquid and the like exist as a remote cause, and a phenomenon that can be considered as cavitation occurs. The mixed air-bubbles, the pulsation, and the like make the liquid column 21 unstable. Therefore, it is essential to cause a large amount of raw material liquid to preliminarily flow until a constant raw material liquid flow is formed before the start of injection of the raw material liquid. It should be noted that also just before the end of injection of the raw material liquid, if the raw material liquid stays on the inflow surface S1 or the raw material liquid flow stagnates in the inflow port H1, air-bubbles are mixed in the raw material liquid that flows out of the injection port H2 or pulsation occurs in the raw material liquid that flows out of the injection hole 51. Thus, at the end of injection of the raw material liquid, it is essential to finish the treatment with a large amount of raw material liquid left in the supply system in order to ensure a constant raw material liquid flow.

In view of this point, the region in which the contact angle decreases in the direction of facing the hole inner surface 51S from the inflow surface S1 produces driving force for forcing the raw material liquid positioned at the boundary between the inflow surface S1 and the hole inner surface 51S to flow toward the hole inner surface 51S from the inflow surface S1. Moreover, as in the above-mentioned configuration (i), the region in which the contact angle decreases in the direction of facing the hole inner surface 51S from the inflow surface S1 produces driving force for forcing the raw material liquid that is positioned around the inflow port H1 to flow toward the inflow port H1. Moreover, as in the above-mentioned configuration (ii), the region in which the contact angle decreases in the direction of facing the hole inner surface 51S from the inflow surface S1 makes the raw material liquid flow smooth inside the injection hole 51 and produces driving force for directing the raw material liquid flow toward the injection port H2 from the inflow port H1.

Therefore, the region in which the contact angle decreases in the direction of facing the hole inner surface 51S from the inflow surface S1 makes the raw material liquid flow smooth at the start of injection or the end of injection, and suppresses the mixing of the air-bubbles and the pulsation of the flow. As a result, the amount of discharge of the raw material liquid before the start of injection of the raw material liquid is reduced or the residual amount of the raw material liquid prepared at the end of injection of the raw material liquid is reduced. It should be noted that the smooth raw material liquid flow in vicinity of the inflow port H1 can be considered as a flow having fluid resistance lower than at the upstream in the above-mentioned vicinity in the contact interface between the injection nozzle 43 and the raw material liquid.

Moreover, while the raw material liquid is being injected, a part of the raw material liquid injected from the injection port H2 does not form the liquid column 21 or is separated (divided) from the liquid column 21, and is scattered as minute droplets toward the periphery of the injection port H2. Especially in the raw material liquid having higher viscosity, a larger number of minute droplets can be formed as compared to a raw material liquid having lower viscosity, such as water. A larger number of scattered minute droplets arrive around the injection port H2 and are dried by self-freezing on the injection surface S2. The raw material liquid by self-freezing on the injection surface S2 comes into contact with other raw material liquid and remains as the solid phase without phase transition. Such a raw material liquid in the solid phase changes the injection direction of the raw material liquid and the direction of growth of the liquid column 21.

In view of this point, the region in which the contact angle decreases in the direction of facing the hole inner surface 51S from the injection surface S2 produces driving force for forcing the raw material liquid positioned at the boundary between the injection surface S2 and the hole inner surface 51S to flow back to the hole inner surface 51S from the injection surface S2. Moreover, as in the above-mentioned configuration (iii), the region in which the contact angle decreases in the direction of facing the hole inner surface 51S from the injection surface S2 produces driving force for forcing the raw material liquid that flow out from the injection port H2 to the periphery to flow back to the injection port H2. Moreover, as in the above-mentioned configuration (iv), the region in which the contact angle decreases in the direction of facing the hole inner surface 51S from the injection surface S2 realizes increasing the contact angle near the injection port H2 such that the raw material liquid flow that arrives at the injection port H2 is hardly directed to the outside of the injection port H2. It is thus possible to prevent the raw material liquid pushed out of the injection hole 51 from scattering around the injection port H2 and to smoothly form the liquid column 21.

In particular, in a case where the angle of the second frustum tube surface 512S with respect to the cylindrical surface 513S is larger than the difference value between the contact angle in the cylindrical surface 513S and the contact angle of the second frustum tube surface 512S, the liquid column 21 is more smoothly formed due to both of suppression of scattering with the structure of the injection hole 51 and suppression of scattering with the contact angle of the hole inner surface 51S. It should be noted that the suppression of scattering with the structure of the injection hole 51 is switching the path through which the raw material liquid flows from the cylindrical surface 513S to the second frustum tube surface 512S, and accordingly gradually suppressing the contact of the raw material liquid with the hole inner surface 51S at the previous stage of the injection port H2.

As described above, not only at the start of injection and the end of injection, but also during injection, the region in which the contact angle decreases in the direction of facing the hole inner surface 51S from the injection surface S2 makes the raw material liquid flow smooth to thereby suppress scattering of the raw material liquid as the minute droplets and fixing of the scattered minute droplets around the injection port H2. As a result, the smooth flow of the raw material liquid is realized, and the occurrence of variations in particle diameters and the like of the matter generated by freeze-drying is suppressed.

It should be noted that the smooth raw material liquid flow in vicinity of the injection port H2 can also be considered as a phenomenon where a surface of a liquid column L1 which is not divided and has a constant shape is continuously newly formed with the pushed out raw material liquid. Even if there are divided raw material liquids and the like, the respective surfaces are rapidly combined with the surface of the liquid column L1 due to the driving force toward the injection port H2 and a dynamically stable flow is thus formed. This may be the definition for “smooth”.

Thus, the following effects can be obtained in accordance with the above-mentioned embodiments.

(1) In a case where the target surface is the injection surface S2, the raw material liquid produces driving force to return the raw material liquid in the direction of facing the hole inner surface 51S from the injection surface S2, and scattering of the raw material liquid around the injection port H2 is suppressed.

(2) In a case where the target surface is the inflow surface S1, the raw material liquid produces driving force to force the raw material liquid to flow in the direction of facing the hole inner surface 51S from the inflow surface S1, and the raw material liquid is forced to flow into the injection hole 51 without stagnation at the start of injection of the raw material liquid or the end of injection of the raw material liquid. That is, a smooth flow of the raw material liquid is realized.

(3) In a case where the contact angle decreases in the direction of facing the hole inner surface 51S from the injection surface S2 and the contact angle decreases in the injection port H2, the raw material liquid positioned at the boundary between the injection surface S2 and the hole inner surface 51S produces driving force to be forced to flow back into the injection hole 51. Accordingly, scattering around the injection port H2 is more effectively suppressed.

(4) As in (ii) above, in a case where the hole inner surface 51S includes the region in which the contact angle decreases in the inflow direction DH1, it is possible to force the raw material liquid positioned in the inside of the injection hole 51 to smoothly flow along the hole inner surface 51S.

(5) As in (iv) above, in a case where the hole inner surface 51S includes the region in which the contact angle decreases in the counter inflow direction DH2, the raw material liquid is forced to flow toward the injection port H2 such that the raw material liquid flow when arriving at the injection port H2 is directed to the outside of the injection port H2. Accordingly, scattering of the raw material liquid pushed out of the injection hole 51 around the injection port H2 is suppressed and the liquid column L1 can be smoothly formed.

(6) In a case where the contact angle stepwisely decreases, effects according to (1) to (5) above are obtained depending on whether or not surface machining is performed, e.g., the presence/absence of a surface layer having a liquid-repellent property or the presence/absence of a surface structure having a liquid-repellent property. Accordingly, it is also possible to suppress the increase in production load for the injection nozzle as compared to production to gradually change the degree of surface machining in the injection nozzle.

(7) In a case where the injection hole 51 is a circular hole having a constant diameter, it is also possible to easily perform hole machining from the inflow port H1 to the injection port H2 and to easily ensure the accuracy of the hole dimension.

(8) In a case where the angle formed by the cylindrical surface 513S and the second frustum tube surface 512S is larger than the difference value between the contact angle of the cylindrical surface 513S and the contact angle of the second frustum tube surface 512S, it is also possible to suppress scattering around the injection port H2 with the structure of the injection hole 51 besides guiding the raw material liquid with the contact angle.

(9) In a case where the region in which the contact angle decreases in the direction of facing the hole inner surface 51S from the target surface is provided using the difference between the surface irregularities structure and the surface roughness, effects according to (1) to (8) above are obtained by such a general-purpose method to perform surface machining on the injection nozzle 43.

(10) According to (1) to (9) above, the raw material liquid can be injected at desired injection initial velocity. It is thus possible to generate frozen particles having a maximum diameter of 200 μm or less that does not deteriorate a solute or dispersoid and to realize a compact vacuum freeze-drying apparatus capable of producing frozen particles of a raw material liquid in a shorter travel distance (1 m or less).

It should be noted that the above-mentioned embodiments can be carried out by changing them in the following manner.
The cover like the fixation ring 44 may have a hole having a diameter increased toward the inner space of the freezing chamber 2 from the injection hole 51. That is, the hole of the cover may have a frustum tube surface shape that is tapered toward the injection hole 51. Alternatively, the hole of the cover may be a cylindrical surface shape having a diameter sufficiently larger than the injection hole 51.
The surface of the cover may also have a liquid-repellent property to repel liquid components of the raw material liquid. With this configuration, it is also possible to further suppress depositing of the freeze-dry matter around the injection hole 51. It should be noted that regarding the liquid-repellent property of the surface of the cover, the cover itself may be constituted by a material having a liquid-repellent property, and the surface of the cover may be constituted by a liquid-repellent layer.
The liquid-repellent layer may be a water-repellent silane coupling agent applied to the surface of the injection nozzle 43.
The constituent material of the injection nozzle 43 may be, for example, a water-repellent resin such as PTFE, PFA, and FEP. At this time, the liquid-repellent layer may be omitted, and the outer surface of the injection nozzle 43 may be a surface having a liquid-repellent property, which is an outer surface of the injection nozzle. That is, the liquid-repellent property in the outer surface of the injection nozzle may be provided by the liquid-repellent property of the injection nozzle 43.
For the region in which the contact angle continuously decreases, a configuration in which two types of regions having contact angles are arranged in a comb teeth shape may be employed. As viewed facing the inflow surface S1, each tooth of the comb teeth shape of the region in which the contact angle continuously decreases in the inflow surface S1 may be constituted by oblique lines of an isosceles triangle, and the area of one region having the contact angle may be continuously changed from 0% to 100% in a direction of facing the top portion from the bottom portion of the isosceles triangle. Also as viewed facing the injection surface S2, each tooth of the comb teeth shape of the region in which the contact angle continuously decreases in the injection surface S2 may be constituted by oblique lines of an isosceles triangle and the area of one region having the contact angle may be continuously changed from 0% to 100% in a direction of facing the top portion from the bottom portion of the isosceles triangle.

That is, for the region in which the contact angle continuously decreases, a configuration in which one of the respective areas of the two types of regions having the contact angles different from each other continuously increases and the other continuously decreases may be employed. With such a configuration, the contact angle per unit area in the two types of regions having the contact angles acts on a liquid matter as a value obtained by combining contributions based on an area ratio of the respective regions having the contact angles, i.e., as a contact angle combined based on an area ratio of the respective contact angles. It should be noted that for example, as long as the tooth pitch width of the comb teeth shape is equal to or smaller than ½ of a droplet diameter assumed as for a divided raw material liquid, it can provide sufficient driving force for divided droplets.
The liquid-repellent layer and the surface irregularities structure may be omitted from the injection hole 51 and may be configured to be positioned only on the injection surface of the injection nozzle. Alternatively, the liquid-repellent layer and the surface irregularities structure may be configured to be positioned only in a portion of the injection surface of the injection nozzle, which surrounds the injection hole 51.
It is sufficient that the direction of facing the hole inner surface 51S from the target surface is at least one of (i) to (iv) above.
The freezing chamber 2 may include a heating mechanism that heats the freeze-dry matter. With the configuration including the heating mechanism, it is also possible to promote drying by heating the freeze-dry matter.

### REFERENCE SIGNS LIST

1 vacuum freeze-drying apparatus
2 freezing chamber
3 drying chamber
4 gate valve
5, 6 cold trap
7 tray
8 heating apparatus
9 raw material tank
10, 14 vacuum evacuation apparatus
11, 15 vacuum gauge
12 raw material liquid supply amount adjustment apparatus (injection amount adjustment apparatus)
13, 16 exhaust amount adjustment apparatus
20 injection nozzle
21 columnar raw material liquid (liquid column)
30, 31, 32 droplet or frozen particle
35 frozen particle
41 injector
42 introduction pipe
42A support ring
43 injection nozzle
44 fixation ring
45 clamping member
51 injection hole
511S first frustum tube surface
512S second frustum tube surface
513S cylindrical surface

1. A vacuum freeze-drying method that includes steps of injecting a raw material liquid from an injection nozzle inside a vacuum chamber, generating frozen particles by self-freezing of the raw material liquid, and drying the generated frozen particles to thereby produce a dry powder, comprising:
injecting the raw material liquid from the injection nozzle in a state in which the vacuum chamber is maintained at water vapor partial pressure corresponding to a self-freezing temperature of the raw material liquid, such that an injection initial velocity of the raw material liquid from the injection nozzle is 6 m/s or more and 33 m/s or less; and
adjusting, under a condition where a cooling velocity from 20° C. to −25° C. in a case where the injection initial velocity is 13 m/s is 5900° C./s or more, an injection flow rate of the raw material liquid from the injection nozzle or properties of the injection nozzle such that frozen particles having a maximum diameter of 200 μm or less are generated.

2. The vacuum freeze-drying method according to claim 1, wherein
the raw material liquid includes a solvent or dispersion medium and a solute dissolved in the solvent or a dispersoid dispersed in the dispersion medium, viscosity of the solvent or dispersion medium or a composite medium of both is viscosity of pure water or more, and the viscosity of the raw material liquid is 5 mPa·s or less.

3. The vacuum freeze-drying method according to claim 2, wherein
the water vapor partial pressure is maintained at 50 Pa or less, and the solute or dispersoid of the raw material liquid is frozen at a speed that inhibits cells from being damaged and protein and other constituent elements from being deteriorated in vacuum freeze-drying.

4. The vacuum freeze-drying method according to claim 1, wherein
an injection pressure of the raw material liquid from the injection nozzle is adjusted in a range of 0.03 MPa or more and 0.7 MPa or less.

5. An injection nozzle that is an injection nozzle for a vacuum freeze-drying apparatus that injects a raw material liquid at an injection initial velocity of 6 m/s or more and 33 m/s or less inside a vacuum chamber and generates frozen particles by self-freezing of the raw material liquid, comprising:
an inflow surface that defines an inflow port for the raw material liquid;
an injection surface that defines an injection port for the raw material liquid; and
a hole inner surface that defines an injection hole for causing the inflow port and the injection port to communicate with each other, wherein
at least one of the inflow surface or the injection surface is a target surface, and
a region in which a contact angle decreases in a direction of facing the hole inner surface from the target surface is provided in a surface constituted by the target surface and the hole inner surface.

6. The injection nozzle according to claim 5, wherein
the target surface includes the injection surface, and
a surface constituted by the inflow surface and the injection surface includes, at a boundary between the injection surface and the hole inner surface, the region in which the contact angle decreases in a direction of facing the hole inner surface from the injection surface.

7. The injection nozzle according to claim 5 or 6, wherein
the hole inner surface includes a region in which a contact angle decreases in a direction of entering the hole inner surface from the target surface.

8. The injection nozzle according to claim 7, wherein
the hole inner surface is provided with a groove extending to the injection port from the inflow port such that a contact angle decreases in the direction of facing the hole inner surface from the target surface.

9. The injection nozzle according to claim 5, wherein
the target surface and the hole inner surface include a region in which a contact angle stepwisely decreases in the direction of facing the hole inner surface from the target surface.

10. The injection nozzle according to claim 5, wherein
the injection hole is a circular hole extending to the injection port from the inflow port and having a constant diameter.

11. The injection nozzle according to claim 5, wherein
the hole inner surface includes
a first frustum tube surface having the inflow port as a bottom portion,
a second frustum tube surface having the injection port as a bottom portion, and
a cylindrical surface that connects the first frustum tube surface and the second frustum tube surface to each other,
at least one of the first frustum tube surface or the second frustum tube surface is a target tube surface, and
a contact angle of the cylindrical surface is smaller than a contact angle of the target tube surface.

12. The injection nozzle according to claim 11, wherein
the target tube surface includes the second frustum tube surface, and
an angle of the second frustum tube surface with respect to the cylindrical surface is larger than a difference value between the contact angle of the cylindrical surface and a contact angle of the second frustum tube surface.

13. The injection nozzle according to claim 5, wherein
a difference in surface roughness is provided in a surface constituted by the target surface and the hole inner surface such that a contact angle decreases in the direction of facing the hole inner surface from the target surface.

14. A vacuum freeze-drying apparatus comprising the injection nozzle according to claim 5.

15. The vacuum freeze-drying apparatus according to claim 14, further comprising:
a vacuum chamber in which the injection nozzle is installed and in which a container that holds frozen particles generated by self-freezing is capable of being placed;
a raw material tank that stores a raw material liquid viscosity of which is viscosity of pure water or more and 5 mPa·s or less and supplies the raw material liquid into the injection nozzle;
a cold trap for removing moisture inside the vacuum chamber;
a heating apparatus for drying frozen particles held in the container;
an exhaust amount adjustment apparatus that adjusts an exhaust amount together with the cold trap such that the vacuum chamber is maintained at the water vapor partial pressure corresponding to the self-freezing temperature of the raw material liquid; and
an injection amount adjustment apparatus that adjusts, under a condition where the injection initial velocity of the raw material liquid from the injection nozzle is 6 m/s or more and 33 m/s or less and a cooling velocity from 20° C. to −25° C. in a case where the injection initial velocity is 13 m/s is 5900° C./s or more, the injection flow rate of the raw material liquid from the injection nozzle or the properties of the injection nozzle such that frozen particles having a maximum diameter of 200 μm or less are generated at a height position of 1 m or less from the injection nozzle.

16. The vacuum freeze-drying apparatus according to claim 15, wherein
the vacuum chamber includes
a freezing chamber that generates frozen particles of the raw material liquid and
a drying chamber that is connected to the freezing chamber via a gate valve and dries frozen particles held in the container.
